(19) United States
(12) Patent Application Publication
(10) Pub. No.: US 2024/0368372 A1
(43) Pub. Date: Nov. 7, 2024

(54) POSITIVE TEMPERATURE COEFFICIENT POLYMER COMPOSITION AND POSITIVE TEMPERATURE COEFFICIENT CIRCUIT PROTECTION DEVICE

(71) Applicant: FUZETEC TECHNOLOGY CO., LTD., New Taipei City (TW)

(72) Inventors: Jack Jih-Sang CHEN, New Taipei City (TW); Chang-Hung JIANG, New Taipei City (TW)

(21) Appl. No.: 18/311,756

(22) Filed: May 3, 2023

(51) Int. Cl. C08K 3/04

(52) U.S. Cl. CPC C08K 3/041; C08K 3/042; C08K 2201/001; C08K 2201/014

(57) ABSTRACT

A positive temperature coefficient (PTC) polymer composition includes a polymer component and a conductive filler component that is dispersed within the polymer component and that includes a first conductive filler and a second conductive filler. The first conductive filler is a zero-dimensional carbon-based material, and the second conductive filler is one of a one-dimensional carbon-based material, a two-dimensional carbon-based material, and a combination thereof. A PTC circuit protection device is also disclosed.

### FIELD

The disclosure relates to a positive temperature coefficient (PTC) polymer composition for making a PTC circuit protection device, and more particularly to a PTC polymer composition that includes a first conductive filler and a second conductive filler and a PTC circuit protection device making therefrom.

### BACKGROUND

A conventional polymeric positive temperature coefficient (PPTC) circuit protection device includes a positive temperature coefficient (PTC) polymer layer and two electrodes connected respectively to two opposite surfaces of the PTC polymer layer. The PTC polymer layer includes a polymer matrix and carbon black dispersed within the polymer matrix and used as a conductive filler. Since carbon black has higher electrical resistivity, the conventional PPTC circuit protection device may have lower conductivity, and therefore is limited to low-voltage and low-current applications.

### SUMMARY

Therefore, an object of the disclosure is to provide a PTC circuit protection device that can alleviate at least one of the drawbacks of the prior art.

According to an aspect of the disclosure, there is provided a PTC polymer composition which includes a polymer component and a conductive filler component. The conductive filler component is dispersed within the polymer component and includes a first conductive filler and a second conductive filler. The first conductive filler is a zero-dimensional carbon-based material. The second conductive filler is one of a one-dimensional carbon-based material, a two-dimensional carbon-based material, and a combination thereof.

According to another aspect of the disclosure, there is provided a PTC circuit protection device that includes a PTC polymer layer and two electrodes attached to two opposite sides of the PTC polymer layer. The PTC polymer layer includes the aforesaid PTC polymer composition.

### BRIEF DESCRIPTION OF THE DRAWING

Other features and advantages of the disclosure will become apparent in the following detailed description of the embodiment(s) with reference to the accompanying drawing. It is noted that various features may not be drawn to scale.

FIG. 1 is a schematic view illustrating an embodiment of a PTC circuit protection device according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

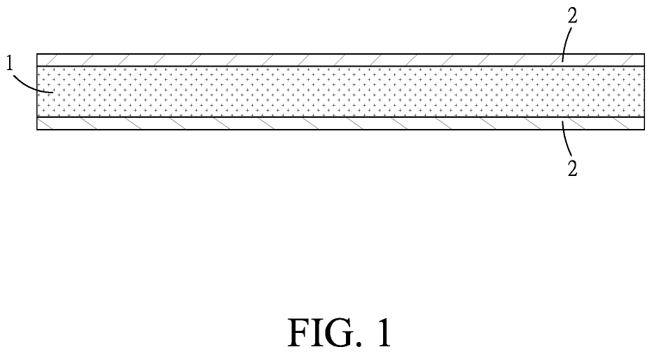

Referring to FIG. 1, an embodiment of a PTC circuit protection device according to the present disclosure includes a PTC polymer layer 1 and two electrodes 2 attached to two opposite sides of the PTC polymer layer 1. The PTC polymer layer 1 includes a PTC polymer composition that includes a PTC polymer component and a conductive filler component containing a first conductive filler and a second conductive filler. The first conductive filler is a zero-dimensional carbon-based material, and the second conductive filler is a one-dimensional carbon-based material, a two-dimensional carbon-based material, or a combination thereof. In some embodiments, the first conductive filler is carbon black, and the second conductive filler is carbon nanotube, graphene, or a combination thereof.

In certain embodiments, the second conductive filler is graphene and is present in an amount greater than 1 wt % and smaller than 25 wt % based on 100 wt % of said PTC polymer composition, e.g., ranging from 2 wt % to 24 wt % or from 5 wt % to 20 wt %.

In certain embodiments, the second conductive filler is carbon nanotube and is present in an amount greater than 1 wt % and smaller than 15 wt % based on 100 wt % of said PTC polymer composition, e.g., ranging from 2 wt % to 14 wt % or from 5 wt % to 10 wt %.

In certain embodiments, the second conductive filler is the combination of graphene and carbon nanotube, and is present in an amount greater than 1 wt % and smaller than 20 wt % based on 100 wt % of said PTC polymer composition, e.g., ranging from 2 wt % to 19 wt %, from 5 wt % to 15 wt %, or from 10 wt % to 15 wt %.

Based on 100 wt % of the PTC polymer composition, the polymer component may be present in an amount ranging from 30 wt % to 50 wt %, e.g., 35 wt % to 45 wt % or 38 wt % to 42 wt %. In certain embodiments, the first conductive filler may be present in an amount ranging from 30 wt % to 60 wt %, e.g., 40 wt % to 55 wt % or 45 wt % to 50 wt %.

In some embodiments, the second conductive filler is graphene, and, based on 100 wt % of the PTC polymer composition, the polymer component is present in an amount ranging from 40 wt % to 45 wt %, the first conductive filler is present in an amount ranging from 40 wt % to 55 wt %, and the second conductive filler is present in an amount ranging from 5 wt % to 20 wt %.

In some embodiments, the second conductive filler is carbon nanotube, and based on 100 wt % of the PTC polymer composition, the polymer component is present in an amount ranging from 40 wt % to 45 wt %, the first conductive filler is present in an amount ranging from 45 wt % to 50 wt %, and the second conductive filler is present in an amount ranging from 5 wt % to 10 wt %.

In some embodiments, the second conductive filler is the combination of graphene and carbon nanotube, and, based on 100 wt % of the PTC polymer composition, the polymer component is present in an amount 15 ranging from 35 wt % to 45 wt %, the first conductive filler is present in an amount ranging from 45 wt % to 55 wt %, and the second conductive filler is present in an amount ranging from 5 wt % to 15 wt %.

In certain embodiments, the second conductive filler has a thickness ranging from 0.1 nm to 100 nm. In some embodiments, the thickness of the second conductive filler ranges from 0.5 nm to 60 nm. In some embodiments, the thickness of the second conductive filler ranges from 0.9 nm to 55 nm. In some embodiments, the thickness of the second conductive filler ranges from 5 nm to 20 nm.

In some embodiments, the second conductive filler is graphene and has the thickness ranging from 0.5 nm to 60 nm, e.g., 0.9 nm, 15 nm or 55 nm. In some embodiments, the second conductive filler is carbon nanotube and has the thickness ranging from 40 nm to 60 nm, e.g., 50 nm. In some embodiments, the second conductive filler is the mixture of graphene and carbon nanotube and has the thickness ranging from 40 nm to 60 nm, e.g., 50 nm.

In some embodiments, graphene has a lateral dimension D50 greater than 1.0 μm and less than 150 μm. In other embodiments, graphene has the lateral dimension D50 greater than 1.0 μm and less than 10 μm.

In this embodiment, the two electrodes 2 are made of a conductive material, e.g., a metal material, such as metal foil, plated foil (e.g., nickel-plated copper foil), etc.

The PTC polymer layer 1 may have a resistivity smaller than 0.1 Ω-cm at room temperature. Thus, the PTC circuit protection device may also have a resistivity smaller than 0.1 Ω-cm. The PTC circuit protection device may be operated under a pressure no greater than 6 V_{dc} and a current no greater than 100 A.

The polymer component includes a non-grafted olefin-based polymer. In some embodiments, the non-grafted olefin-based polymer is non-grafted high density polyethylene (HDPE) having a weight average molecular weight ranging from 50,000 g/mol to 300,000 g/mol. The polymer component may further include a grafted olefin-based polymer. In certain embodiments, the grafted olefin-based polymer is unsaturated carboxylic acid anhydride-grafted olefin-based polymer. Example of the unsaturated carboxylic acid anhydride-grafted polyolefin is an unsaturated carboxylic acid anhydride-grafted HDPE.

Examples and comparative examples of the disclosure will be described hereinafter. It is to be understood that these examples and comparative examples are exemplary and explanatory and should not be construed as a limitation to the disclosure.

### Example 1 (E1)

10 g of high density polyethylene (HDPE), 10 g of unsaturated carboxylic acid anhydride-grafted high density polyethylene (G-HDPE), 27.5 g of carbon black as the first conductive filler (trade name: Raven 430UB, DBP/D=0.95, bulk density=0.53 g/cm³, electrical conductivity=2.86×10⁴ m⁻¹Ω⁻¹, commercially available from Columbian Chemicals Company) and 2.5 g of graphene (hereinafter referred to as graphene A) as the second conductive filler (trade name: R-PG, thickness=0.9 nm, commercially available from Taiwan Carbon Materials Corp.) were blended in a Brabender blender. The blending temperature was 200° C., the mixing rate was 60 rpm, and the blending time was 10 minutes. The blended mixture was placed in a mold, and was then heated and pressed using a hot press machine to form a PTC polymer sheet having a thickness of 0.33 mm. The hot press temperature was 200° C., the hot press time was 4 minutes, and the hot press pressure was 80 kg/cm². Thereafter, two nickel plated copper foils were attached to two opposite sides of the PTC polymer sheet, followed by a hot pressing procedure under the same conditions as that performed in formation of the PTC polymer layer 1, thereby obtaining a sandwich structure having a thickness of 0.4 mm. The sandwich structure was cut into a plurality of PTC test samples (i.e., the PTC circuit protection devices) each of which has a size of 8 mm×8 mm. Each of the PTC test samples was irradiated with a Cobalt-60 gamma ray for a total irradiation dose of 150 kGy, and its resistance was measured. The average resistance (R₂₅) and the average volume resistivity (VR) of ten PTC test samples at 25° C. were measured and calculated, and the results are shown in Table 1 below.

TABLE 1

| | Formula | | | | | | | |
|---|---|---|---|---|---|---|---|---|
| | HDPE | G-HDPE | 1^{st} conductive filler | | 2^{nd} conductive filler | | PTC Test Sample | |
| Sample | wt % | wt % | Material | wt % | Material | wt % | R₂₅ ohm | VR ohm-cm |
| E1 | 20.0 | 20.0 | Carbon Black | 55.0 | Graphene-A | 5.0 | 0.0053 | 0.0848 |
| E2 | 20.0 | 20.0 | Carbon Black | 50.0 | Graphene-A | 10.0 | 0.0049 | 0.0784 |
| E3 | 20.0 | 20.0 | Carbon Black | 45.0 | Graphene-A | 15.0 | 0.0050 | 0.0800 |
| E4 | 20.0 | 20.0 | Carbon Black | 40.0 | Graphene-A | 20.0 | 0.0051 | 0.0816 |
| E5 | 20.0 | 20.0 | Carbon Black | 55.0 | Graphene-B | 5.0 | 0.0049 | 0.0784 |
| E6 | 20.0 | 20.0 | Carbon Black | 50.0 | Graphene-B | 10.0 | 0.0044 | 0.0704 |
| E7 | 20.0 | 20.0 | Carbon Black | 45.0 | Graphene-B | 15.0 | 0.0047 | 0.0752 |
| E8 | 20.0 | 20.0 | Carbon Black | 40.0 | Graphene-B | 20.0 | 0.0049 | 0.0784 |
| E9 | 20.0 | 20.0 | Carbon Black | 55.0 | Graphene-C | 5.0 | 0.0054 | 0.0864 |
| E10 | 20.0 | 20.0 | Carbon Black | 50.0 | Graphene-C | 10.0 | 0.0049 | 0.0784 |
| E11 | 20.0 | 20.0 | Carbon Black | 45.0 | Graphene-C | 15.0 | 0.0051 | 0.0816 |
| E12 | 20.0 | 20.0 | Carbon Black | 40.0 | Graphene-C | 20.0 | 0.0053 | 0.0848 |
| E13 | 20.0 | 20.0 | Carbon Black | 55.0 | Carbon | 5.0 | 0.0060 | 0.0960 |
| | | | | | Nanotube | | | |
| E14 | 20.0 | 20.0 | Carbon Black | 50.0 | Carbon | 10.0 | 0.0058 | 0.0928 |
| | | | | | Nanotube | | | |
| E15 | 20.0 | 20.0 | Carbon Black | 55.0 | Graphene + | 5.0 | 0.0050 | 0.0800 |
| | | | | | Carbon | | | |
| | | | | | Nanotube | | | |
| E16 | 20.0 | 20.0 | Carbon Black | 50.0 | Graphene + | 10.0 | 0.0049 | 0.0784 |
| | | | | | Carbon | | | |
| | | | | | Nanotube | | | |
| E17 | 20.0 | 20.0 | Carbon Black | 45.0 | Graphene + | 15.0 | 0.0051 | 0.0816 |
| | | | | | Carbon | | | |
| | | | | | Nanotube | | | |
| CE 1 | 20.0 | 20.0 | Carbon Black | 60.0 | | | 0.0065 | 0.1040 |
| CE 2 | 22.5 | 22.5 | | | Graphene-A | 55.0 | 0.0045 | 0.0720 |
| CE 3 | 22.5 | 22.5 | | | Graphene-B | 55.0 | 0.0040 | 0.0640 |
| CE 4 | 22.5 | 22.5 | | | Graphene-C | 55.0 | 0.0048 | 0.0768 |
| CE 5 | 40.0 | 40.0 | | | Carbon | 20.0 | 0.0072 | 0.1152 |
| | | | | | Nanotube | | | |
| CE 6 | 32.5 | 32.5 | | | Graphene + | 35.0 | 0.0043 | 0.0688 |
| | | | | | Carbon | | | |
| | | | | | Nanotube | | | |
| CE 7 | 20.0 | 20.0 | Carbon Black | 59.0 | Graphene-A | 1.0 | 0.0065 | 0.1040 |
| CE 8 | 20.0 | 20.0 | Carbon Black | 35.0 | Graphene-A | 25.0 | 0.0053 | 0.0848 |
| CE 9 | 20.0 | 20.0 | Carbon Black | 59.0 | Graphene-B | 1.0 | 0.0064 | 0.1024 |
| CE 10 | 20.0 | 20.0 | Carbon Black | 35.0 | Graphene-B | 25.0 | 0.0052 | 0.0832 |
| CE 11 | 20.0 | 20.0 | Carbon Black | 59.0 | Graphene-C | 1.0 | 0.0065 | 0.1040 |
| CE 12 | 20.0 | 20.0 | Carbon Black | 35.0 | Graphene-C | 25.0 | 0.0056 | 0.0896 |
| CE 13 | 20.0 | 20.0 | Carbon Black | 59.0 | Carbon | 1.0 | 0.0070 | 0.1120 |
| | | | | | Nanotube | | | |
| CE 14 | 20.0 | 20.0 | Carbon Black | 45.0 | Carbon | 15.0 | 0.0062 | 0.0992 |
| | | | | | Nanotube | | | |
| CE 15 | 20.0 | 20.0 | Carbon Black | 59.0 | Graphene + | 1.0 | 0.0064 | 0.1024 |
| | | | | | Carbon | | | |
| | | | | | Nanotube | | | |
| CE 16 | 20.0 | 20.0 | Carbon Black | 40.0 | Graphene + | 20.0 | 0.0051 | 0.0816 |
| | | | | | Carbon | | | |
| | | | | | Nanotube | | | |

### Examples 2-4 (E2-4)

The processes and conditions for preparing the PTC test samples of Examples 2-4 were the same as those of Example 1 except for the amounts of carbon black and graphene A. The average resistance and the average volume resistivity of ten PTC test samples in each of E2 to E4 are listed in Table 1.

### Examples 5-8 (E5-8)

The processes and conditions for preparing the PTC test samples of Examples 5-8 were the same as those of Example 1 except for the amount of carbon black, and the material and the amount of the second conductive filler. To be specific, graphene B (trade name: HMG-20, thickness=15 nm, commercially available from Taiwan Carbon Materials Corp.) was used as the second conductive filler. The average resistance and the average volume resistivity of ten PTC test samples in each of E5 to E8 are listed in Table 1.

### Examples 9-12 (E9-12)

The processes and conditions for preparing the PTC test samples of Examples 9-12 were the same as those of Example 1 except for the amount of carbon black, and the material and the amount of the second conductive filler. To be specific, graphene C (trade name: LGF-50, thickness >55 nm, commercially available from Taiwan Carbon Materials Corp.) was used as the second conductive filler. The average resistance and the average volume resistivity of ten PTC test samples in each of E9 to E12 are listed in Table 1.

### Examples 13-14 (E13-14)

The processes and conditions for preparing the PTC test samples of Examples 13-14 were the same as those of Example 1 except for the amount of carbon black, and the material and the amount of the second conductive filler. To be specific, carbon nanotube (trade name: TSCNT-C, thickness=50 nm, density=0.015 g/cm³, commercially available from Taiwan Carbon Materials Corp.) was used as the second conductive filler. The average resistance and the average volume resistivity of ten PTC test samples in each of E13 to E14 are listed in Table 1.

### Examples 15-17 (E15-17)

The processes and conditions for preparing the PTC test samples of Examples 15-17 were the same as those of Example 1 except for the amount of carbon black, and the material and the amount of the second carbon conductive filler. To be specific, the mixture of graphene and carbon nanotube (trade name: TRM-016-P, average thickness=50 nm, density=2.0 g/cm³, commercially available from Taiwan Carbon Materials Corp.). The average resistance and the average volume resistivity of ten PTC test samples in each of E15 to E17 are listed in Table 1.

### Comparative Examples 1-16 (CE1-CE16)

The processes and conditions for preparing the PTC test samples of comparative examples 1-16 were the same as those of Example 1 except for the amounts of HDPE and G-HDPE, the amount of carbon black and/or the materials and amounts of the second conductive filler (see Table 1). The average resistance and the average volume resistivity of ten PTC test samples in each of CE1 to CE16 are listed in Table 1.

### Performance Test

Table 2 shows the resistance at 140 degrees Celsius of the ten PTC test samples of each of Examples 1-17 (E1-E17) and Comparative Examples 1-16 (CE1-CE16). In the test, each of the PTC test samples was placed in an oven, and was heated from 25° C. to 150° C. at a heating rate of 1° C./min. The resistance at 140° C. (R₁₄₀) was measured. The resistance (R₂₅) measured at 25° C. and the resistance (R₁₄₀) measured at 140° C. were recorded using a data acquisition instrument (Agilent 34970A) with a scanning rate of 1 time/sec. Table 1 shows that the R₂₅ value of each of the Examples 1-17 is smaller than 0.006 ohm and that the VR value of each of the Examples 1-17 is smaller than 0.1 ohm-cm. Comparative Examples 1-6 have only one conductive filler, in which Comparative Example 3 having Graphene B, has the lowest average resistance (0.004 ohm) and the lowest average volume resistivity (0.06 ohm-cm).

Table 2 shows that the R₁₄₀ value of each of the Examples 1-17 is greater than 10 ohm, and that Log (R₁₄₀/R₂₅) value of each of the Examples 1-17 is greater than 3.2, which indicates that at 140° C., the resistance will be more than 1000 times greater, thus exhibiting a good PTC effect. On the other hand, for each of the Comparative Examples 1-16, the R₁₄₀ value is smaller than 5.5 ohm, and the Log (R₁₄₀/R₂₅) value is smaller than 2.9, thus exhibiting poor PTC effect.

TABLE 2

| | Electrical property | | | | | |
|---|---|---|---|---|---|---|
| | Resistance | | 6 V_{dc}/100 A, | | 6 V_{dc}/100 A, | |
| | at 140° C. | PTC | 6000 cycles test | | 1000 hours test | |
| Test | R₁₄₀ | effect | | R_{f}/Rᵢ | | R_{f}/Rᵢ |
| Sample | ohm | Log(R₁₄₀/R₂₅) | R_{f} | % | R_{f} | % |
| E1 | 15.50 | 3.5 | 0.039 | 736% | 0.012 | 226% |
| E2 | 17.26 | 3.5 | 0.036 | 735% | 0.010 | 204% |
| E3 | 16.98 | 3.5 | 0.038 | 760% | 0.011 | 220% |
| E4 | 12.30 | 3.4 | 0.038 | 745% | 0.011 | 216% |
| E5 | 18.05 | 3.6 | 0.029 | 592% | 0.008 | 163% |
| E6 | 25.64 | 3.8 | 0.025 | 568% | 0.006 | 136% |
| E7 | 20.80 | 3.6 | 0.028 | 596% | 0.007 | 149% |
| E8 | 19.01 | 3.6 | 0.029 | 592% | 0.008 | 163% |
| E9 | 14.66 | 3.4 | 0.040 | 741% | 0.013 | 241% |
| E10 | 16.79 | 3.5 | 0.036 | 735% | 0.011 | 224% |
| E11 | 13.78 | 3.4 | 0.038 | 745% | 0.012 | 235% |
| E12 | 10.21 | 3.3 | 0.039 | 736% | 0.012 | 226% |
| E13 | 11.26 | 3.3 | 0.039 | 650% | 0.013 | 217% |
| E14 | 10.12 | 3.2 | 0.036 | 621% | 0.012 | 207% |
| E15 | 15.10 | 3.5 | 0.038 | 760% | 0.012 | 240% |
| E16 | 16.69 | 3.5 | 0.034 | 694% | 0.010 | 204% |
| E17 | 16.82 | 3.5 | 0.037 | 725% | 0.011 | 216% |
| CE1 | 5.50 | 2.9 | Burned | NA | Burned | NA |
| CE2 | 1.24 | 2.4 | Burned | NA | Burned | NA |
| CE3 | 1.35 | 2.5 | Burned | NA | Burned | NA |
| CE4 | 1.13 | 2.4 | Burned | NA | Burned | NA |
| CE5 | 0.85 | 2.1 | Burned | NA | Burned | NA |
| CE6 | 0.75 | 2.2 | Burned | NA | Burned | NA |
| CE7 | 5.11 | 2.9 | Burned | NA | Burned | NA |
| CE8 | 2.20 | 2.6 | Burned | NA | Burned | NA |
| CE9 | 5.60 | 2.9 | Burned | NA | Burned | NA |
| CE10 | 2.98 | 2.8 | Burned | NA | Burned | NA |
| CE11 | 4.92 | 2.9 | Burned | NA | Burned | NA |
| CE12 | 2.10 | 2.6 | Burned | NA | Burned | NA |
| CE13 | 3.95 | 2.8 | Burned | NA | Burned | NA |
| CE14 | 0.90 | 2.2 | Burned | NA | Burned | NA |
| CE15 | 4.60 | 2.9 | Burned | NA | Burned | NA |
| CE16 | 2.47 | 2.7 | Burned | NA | Burned | NA |

### Switching Cycle Test

Ten PTC test samples of each of E1-E17 and CE1-CE16 were subjected to a switching cycle test to determine variation of the resistances of the PTC test samples. The switching cycle test was conducted under a voltage of 6 V_{dc} and a current of 100 A by switching each of the PTC test samples on for 60 seconds and then off for 60 seconds per cycle for 6000 cycles according to the Underwriter Laboratories UL 1434 Standard for Safety for Thermistor-Type Devices. The resistances of each of the PTC test samples before (Rᵢ) and after (R_{f}) the 6000 cycles were measured. A percentage of average resistance variation (R_{f}/Rᵢ×100%) of the PTC test samples of each of E1-E17 and CE1-CE16 was calculated. The results of the switching cycle test are shown in Table 2.

The results in Table 2 show that the PTC test samples of E1-E17 have an average resistance variation rate ranging from 568% to 760%. The average resistance variation rate of the PTC test samples of CE-CE16 are not available because the PTC test samples of CE-CE16 were all burnt during the switching cycle test.

### Aging Test

Ten PTC test samples of each of E1-E17 and CE1-CE16 were subjected to an aging test to determine variation of the resistances of the PTC test samples. The aging test was conducted by applying a voltage of 6 V_{dc} and a current of 100 A to each of the PTC test samples for 1000 hours using a power supply (purchased from IDRC; Model: DSP-060-050), according to the Underwriter Laboratories UL 1434 Standard for Safety for Thermistor-Type Devices. The resistances of each of the PTC test samples before (Rᵢ) and after (R_{f}) the 1000 hours were measured. A percentage of average resistance variation (R_{f}/Rᵢ×100%) of the PTC test samples of each of E1-E17 and CE1-CE16 was calculated. The results of the aging test are shown in Table 2.

The results in Table 2 show that the PTC test samples of E1-E17 have an average resistance variation rate ranging from 136% to 241%. The average resistance variation rate of the PTC test samples of CE1-CE16 are not available because the PTC test samples of CE1-CE16 were all burnt during the aging test.

According to the results of the switching cycle test and the aging test, although conductivity of graphene is better than that of carbon black, due to graphene having a relatively flat structure, for the PTC test samples having just graphene as the conductive filler, a conductive path at high temperature during tripping was limited, so the resistance at 140° C. (R₁₄₀) could not jump to block high currents from passing therethrough, and therefore these PTC test samples were burnt.

On the other hand, the PTC test samples of E1-E17 having both carbon black and graphene exhibit good PTC effect and conductivity. Under a specific ratio of carbon black to graphene, the PTC circuit protection device may have both low resistance and good PTC effect. In some embodiments, the PTC circuit protection device having graphene in an amount of 10 wt % achieves both low resistance and good PTC effect.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A positive temperature coefficient (PTC) polymer composition for making a PTC circuit protection device, comprising:
a polymer component; and
a conductive filler component that is dispersed within said polymer component and that includes a first conductive filler and a second conductive filler, said first conductive filler being a zero-dimensional carbon-based material, said second conductive filler being one of a one-dimensional carbon-based material, a two-dimensional carbon-based material, and a combination thereof.

2. The PTC polymer composition as claimed in claim 1, wherein said first conductive filler is carbon black.

3. The PTC polymer composition as claimed in claim 1, wherein said second conductive filler is one of carbon nanotube, graphene, and a combination thereof.

4. The PTC polymer composition as claimed in claim 1, wherein said first conductive filler is carbon black, and said second conductive filler is graphene and is present in an amount greater than 1 wt % and smaller than 25 wt % based on 100 wt % of said PTC polymer composition.

5. The PTC polymer composition as claimed in claim 4, wherein said second conductive filler is present in an amount ranging from 2 wt % to 24 wt % based on 100 wt % of said PTC polymer composition.

6. The PTC polymer composition as claimed in claim 5, wherein said second conductive filler is present in an amount ranging from 5 wt % to 20 wt % based on 100 wt % of said PTC polymer composition.

7. The PTC polymer composition as claimed in claim 6, wherein, based on 100 wt % of said PTC polymer composition, said polymer component is present in an amount ranging from 40 wt % to 45 wt %, and said first conductive filler is present in an amount ranging from 40 wt % to 55 wt %.

8. The PTC polymer composition as claimed in claim 1, wherein said first conductive filler is carbon black, and said second conductive filler is carbon nanotube and is present in an amount greater than 1 wt % and smaller than 15 wt % based on 100 wt % of said PTC polymer composition.

9. The PTC polymer composition as claimed in claim 8, wherein said second conductive filler is present in an amount ranging from 2 wt % to 14 wt % based on 100 wt % of said PTC polymer composition.

10. The PTC polymer composition as claimed in claim 9, wherein said second conductive filler is present in an amount ranging from 5 wt % to 10 wt % based on 100 wt % of said PTC polymer composition.

11. The PTC polymer composition as claimed in claim 10, wherein, based on 100 wt % of said PTC polymer composition, said polymer component is present in an amount ranging from 40 wt % to 45 wt %, and said first conductive filler is present in an amount ranging from 45 wt % to 50 wt %.

12. The PTC polymer composition as claimed in claim 1, wherein said first conductive filler is carbon black, and said second conductive filler is a combination of graphene and carbon nanotube and is present in an amount greater than 1 wt % and smaller than 20 wt % based on 100 wt % of said PTC polymer composition.

13. The PTC polymer composition as claimed in claim 12, wherein said second conductive filler is present in an amount ranging from 2 wt % to 19 wt % based on 100 wt % of said PTC polymer composition.

14. The PTC polymer composition as claimed in claim 13, wherein said second conductive filler is present in an amount ranging from 5 wt % to 15 wt % based on 100 wt % of said PTC polymer composition.

15. The PTC polymer composition as claimed in claim 14, wherein, based on 100 wt % of said PTC polymer composition, said polymer component is present in an amount ranging from 35 wt % to 45 wt %, and said first conductive filler is present in an amount ranging from 45 wt % to 55 wt %.

16. The PTC polymer composition as claimed in claim 1, wherein said second conductive filler has a thickness ranging from 0.1 nm to 100 nm.

17. The PTC polymer composition as claimed in claim 1, wherein said polymer component includes a non-grafted olefin-based polymer.

18. The PTC polymer composition as claimed in claim 17, wherein said polymer component further includes a grafted olefin-based polymer.

19. A PTC circuit protection device, comprising:
a PTC polymer layer; and
two electrodes attached to two opposite sides of said PTC polymer layer;
wherein said PTC polymer layer includes a PTC polymer composition as claimed in claim 1.

20. The PTC circuit protection device as claimed in claim 19, wherein said first conductive filler is carbon black, and said second conductive filler is one of carbon nanotube, graphene, and a combination thereof.
